(19) United States
(12) Patent Application Publication
(10) Pub. No.: US 2022/0340110 A1
(43) Pub. Date: Oct. 27, 2022

(54) METHOD FOR CONTROLLING AN ANTI-LOCK BRAKING SYSTEM

(71) Applicant: Robert Bosch GmbH, Stuttgart (DE)

(72) Inventors: Bianka Weber, Beilstein (DE); Lars Koenig, Grossbottwar-Winzerhausen (DE)

(21) Appl. No.: 17/659,108

(22) Filed: Apr. 13, 2022

(30) Foreign Application Priority Data
Apr. 21, 2021 (DE) 10 2021 203 944.8

(51) Int. Cl. B60T 8/1761; B60T 8/172; B60T 8/171

(52) U.S. Cl. CPC B60T 8/1761; B60T 8/172; B60T 8/171; B60T 2250/04; B60T 2270/10

(57) ABSTRACT

A method for controlling an anti-lock braking system in a motor vehicle. The control is carried out based on a wheel slip of at least one of the wheels. A wheel circumferential speed and a groundspeed in the longitudinal direction of the wheel being taken into account to compute the wheel slip. The groundspeed being estimated in terms of value and direction based on signals from sensors that describe all six degrees of freedom in space.

### CROSS REFERENCE

The present application claims the benefit under 35 U.S.C. § 119 of German Patent Application No. DE 10 2021 203 944.8 filed on Apr. 21, 2021, which is expressly incorporated herein by reference in its entirety.

### FIELD

The present invention relates to a method for controlling an anti-lock braking system and a system for carrying out the method. The present invention further relates to a computer program for carrying out the method and to a machine-readable memory medium.

### BACKGROUND INFORMATION

An anti-lock braking system (ABS) is used to counteract a locking of the wheels during a braking operation of a motor vehicle by reducing the brake pressure. For this purpose, a detector or sensor, with the aid of which the rotational speed of the particular wheel is measured, is typically situated at each wheel, at least at each braked wheel. In the case of constant brake force, the wheel rotational speed is reduced proportionally to the elapsed time. If the brake force is no longer transferred to the roadway, the rotational speed of the wheel is abruptly reduced. The abrupt change in the rotational speed associated therewith is detected and the brake pressure at the wheel in question is reduced. The brake force is controlled in this manner. The braking distance may thus be shortened and the maneuverability of the motor vehicle may be improved. This allows the motor vehicle to be safely operated.

The knowledge of the groundspeed of the vehicle in terms of value and direction is an important tool for today's ant-lock braking systems or traction control systems.

To compute the locking tendency, i.e., the slip, of a wheel, the wheel circumferential speed, the groundspeed, and the difference between the two must be put into perspective. For this purpose, various approaches are conventional, but the groundspeed in the longitudinal direction of the wheel is always the subject matter of the approach. The locking level or the wheel slip, in turn, relates to the force transferred by the wheel onto the roadway and thus to the use of the available friction coefficient.

However, the only measured variable available in today's motor vehicles is the wheel rotational speed. The groundspeed must be ascertained by an estimation algorithm. According to the related art, such estimation algorithms usually use the wheel rotational speeds and, potentially, the longitudinal acceleration of the vehicle as well as the yaw rate as the input variables.

The estimation of the groundspeed using the input signals described above is inaccurate. It must be taken into account that in the operating point “ABS braking,” a system is present that may be observed only to a limited extent in terms of regulation. For this reason, either the mark is missed on the state of the maximum friction contact as a result of estimation errors or the speed estimation is supported by reversing the braking operation at individual wheels (“fifth wheel” principle). Both approaches result in that the shortest possible braking distance cannot be achieved under the given friction contact conditions.

A Peiseler tow wheel, which is also referred to as a fifth wheel, is a measuring device, with the aid of which the traveled route of a vehicle may be measured.

### SUMMARY

A method and a system for controlling an anti-lock braking system are provided esented. Furthermore, a computer program as well as a machine-readable memory medium for controlling an anti-lock braking system are provided. Specific embodiments of the present invention are disclosed herein.

The presented method in accordance with the present invention is used to control an anti-lock braking system in a motor vehicle. In this anti-lock braking system, the control is carried out based on a wheel slip of at least one of the wheels. This means that the method may be carried out in the case of at least one of the wheels, some of the wheels or all of the wheels, at least in the case of the driven wheels, of the motor vehicle. The computed wheel slip is typically the ratio of the rotational speed of a driven wheel to the rotational speed of a wheel that is not driven and is thus moving concurrently in a form-fit manner.

A wheel circumferential speed and a groundspeed in the longitudinal direction of the wheel are taken into account to compute the wheel slip, the groundspeed being estimated in terms of value and direction based on signals from sensors that describe all six degrees of freedom in space.

The groundspeed describes the speed of the observed wheel with regard to the ground on which the wheel is moving or rolling.

In one specific embodiment of the present invention, the wheel circumferential speed, the groundspeed, and the difference between the two are put into perspective to compute the wheel slip.

The groundspeed may be furthermore estimated in terms of value and direction based on the signals from three acceleration sensors and three rotational speed sensors. These six sensors in total or the signals received by these enable the description of all six degrees of freedom.

The present invention thus provides in one example embodiment to use for the purpose of ABS control an estimation of the groundspeed in terms of value and direction that is ascertained based on a 6D sensor system or inertial sensor system, i.e., three acceleration sensors and three rotational speed sensors for all six degrees of freedom in space. The estimation may take place, for example, with the aid of a Luenberger observer, a Kalman filter, a particle filter, a neural network, or similar devices.

Instead of a 6D sensor system, a radar sensor or a video camera, or a combination of these may also be used.

A Kalman filter is a mathematical procedure for iterative estimation of parameters that in turn are used to describe system states. This is carried out based on erroneous observations. System variables that are not directly measurable may thus be estimated. To determine dynamic variables, a mathematical model may be added to the Kalman filter as a secondary condition to thus take into account dynamic relationships between the system variables. Movement equations may, for example, contribute to being able to jointly estimate variable positions and speeds in a precise manner.

An observer is used in control engineering to reconstruct non-measurable variables or states from known input variables, such as for example actuating variables or measurable disturbance variables, and output variables, such as for example measured variables, of an observed reference system. For this purpose, the observed reference system is emulated as a model and the state variables that are measurable and thus comparable with the reference system are tracked with the aid of a controller. This is to prevent that a model generates an error that gets greater over time.

The Luenberger observer is based on a parallel circuit of the observer for the controlled system model. Here, the difference between a measured value of the system and a measured value of the observer is referenced back to the model. In this way, the observer is able to respond to disturbances or to its own inaccuracies.

Other sensors, such as for example a steering angle sensor, a wheel rotational speed sensor, a brake pressure sensor, etc., may be additionally used to support the algorithm. Other suitable sensors may also be used.

As a result of the exact knowledge of the wheel slip thus obtained, namely as a function of the groundspeed and the circumferential speed, the braking distance is shortened and the maneuverability is improved.

The presented system in accordance with the present invention is used to carry out the described method and is implemented, for example, in a hardware and/or software. The system, which is used in a control loop of an ABS and may include a controller, may be integrated into a control unit of a motor vehicle or be designed as such.

Further advantages and embodiments of the present invention are derived from the description and the figures.

It is understood that the above-mentioned features and the features to be elucidated below are usable not only in the given combination, but also in other combinations or alone without departing from the scope of the present invention.

### BRIEF DESCRIPTION OF THE DRAWINGS

FIG. 1 shows a simplified representation of a comparison of a conventional control loop with a control loop according to one example embodiment of the present invention.

FIG. 2 shows a schematic representation of a motor vehicle with the aid of one specific example embodiment of the system for carrying out the method in accordance with the present invention.

### DETAILED DESCRIPTION OF EXAMPLE EMBODIMENTS

The present invention is illustrated schematically in the figures on the basis of specific embodiments and is described in greater detail in the following with reference to the figures.

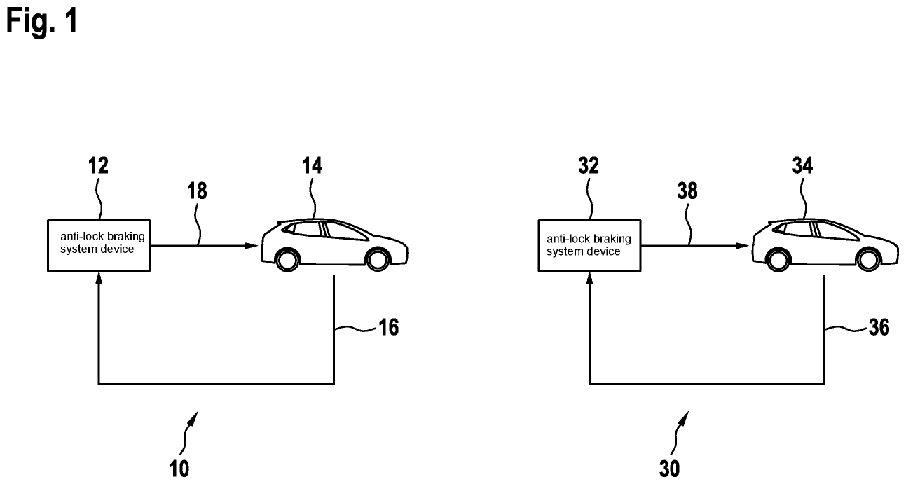

FIG. 1 shows on the left-hand side a control loop 10 for carrying out a conventional method for controlling an anti-lock braking system device 12. Next to it, the representation shows a motor vehicle 14. Variables 16, such as for example wheel speed(s), longitudinal acceleration, yaw rate, steering angle, etc., which are measured and provided by various sensors, are output from motor vehicle 14 into anti-lock braking system device 12, which includes a controller. The anti-lock braking system device outputs a wheel torque as output variable 18.

On the right-hand side of the representation, a control loop 30 is illustrated, with the aid of which a method of the type presented here may be carried out. The representation shows an anti-lock braking system device 32 and a motor vehicle 34. The vehicle outputs as variables 36, in particular as reference variables: wheel speed, 6D sensor variables, steering angle, etc. Anti-lock braking system device 32 outputs a wheel torque as output variable 38.

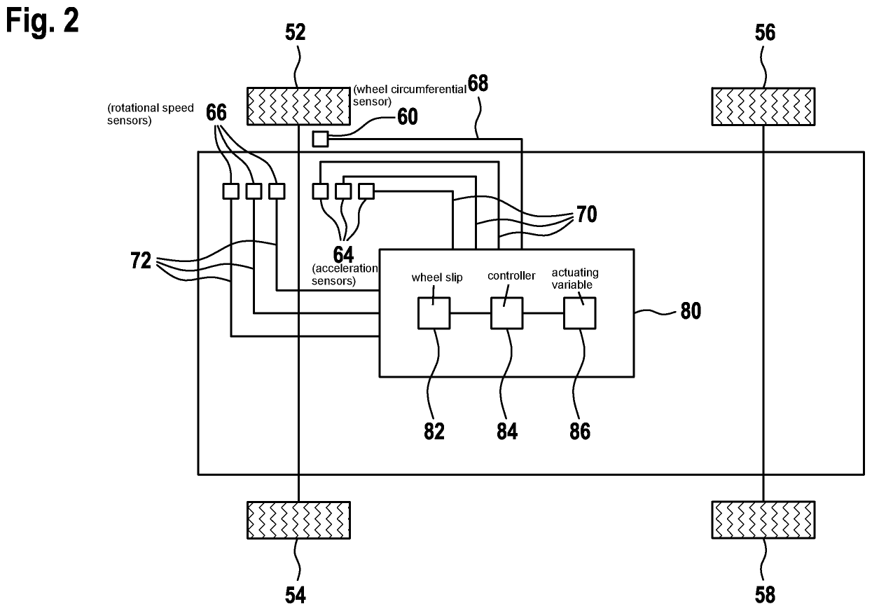

FIG. 2 shows in a schematic representation a motor vehicle that as a whole is identified with reference numeral 50. This vehicle 50 includes two driven wheels 52, 54 and two wheels 56, 58 running together. The presented method is typically carried out for one or multiple driven wheels 52, 54, only wheel 52 being discussed in greater detail for the purpose of simplifying the illustration.

This wheel 52 is now associated with a wheel circumferential sensor 60, with the aid of which the wheel circumferential speed or a variable representing the wheel circumferential speed may be detected. A corresponding wheel circumferential signal 68 is output. Furthermore, wheel 52 is associated with three acceleration sensors 64 and three rotational speed sensors 66. Acceleration sensors 64 provide first signals 70 that describe the acceleration information in three spatial directions. Correspondingly, the rotational speed sensors provide second signals 72 that carry the rotational speed information about three spatial axes.

Instead of acceleration sensors 64 and rotational speed sensors 66, at least one radar sensor and/or at least one video camera may also be used.

Signals 70 and 72 as well as wheel circumferential signal 68 are input into a system 80 that uses these to compute wheel slip 82.

This wheel slip is the input variable or the reference variable of a control and is input into a controller 84 that uses same to ascertain an actuating variable 86, with the aid of which an anti-lock braking system of motor vehicle 50 is activated or acted on.

It is to be noted that the groundspeed of wheel 52 is estimated in terms of value and direction based on signals 70 and 72 from sensors 64 and 66, which describe all six degrees of freedom in space. For this purpose, three acceleration sensors 64 and three rotational speed sensors 66 are provided in this case.

What is claimed is:

1. A method for controlling an anti-lock braking system in a motor vehicle, comprising the following:
controlling the anti-lock braking system based on a wheel slip of at least one of wheel of the motor vehicle, wherein a wheel circumferential speed and a groundspeed in a longitudinal direction of the wheel are taken into account to compute the wheel slip, the groundspeed being estimated in terms of value and direction based on signals from sensors of the motor vehicle that describe all six degrees of freedom in space.

2. The method as recited in claim 1, wherein the wheel circumferential speed, the groundspeed, and a difference between the wheel circumferential speed and the groundspeed are put into perspective to compute the wheel slip.

3. The method as recited in claim 1, wherein the groundspeed is estimated in terms of value and direction based on signals from three acceleration sensors and three rotational speed sensors.

4. The method as recited in claim 3, wherein the estimation of the groundspeed is carried out using at least one element that is selected from: Luenberger observer, Kalman filter, particle filter, neural network.

5. The method as recited in claim 3, wherein at least one further sensor is used to support the algorithm for carrying out the method.

6. The method as recited in claim 5, wherein the at least one further sensor is selected from a set that includes: a steering angle sensor, a wheel rotational speed sensor, a brake pressure sensor.

7. A system for controlling an anti-lock braking system, the system configured to:
control the anti-lock braking system based on a wheel slip of at least one of wheel of the motor vehicle, wherein a wheel circumferential speed and a groundspeed in a longitudinal direction of the wheel are taken into account to compute the wheel slip, the groundspeed being estimated in terms of value and direction based on signals from sensors of the motor vehicle that describe all six degrees of freedom in space.

8. The system as recited in claim 7, wherein the system includes a controller.

9. A non-transitory machine-readable memory medium on which is stored a computer program having program code for controlling an anti-lock braking system in a motor vehicle, the program code, when executed by a processing unit, causing the processing unit to perform the following:
controlling the anti-lock braking system based on a wheel slip of at least one of wheel of the motor vehicle, wherein a wheel circumferential speed and a groundspeed in a longitudinal direction of the wheel are taken into account to compute the wheel slip, the groundspeed being estimated in terms of value and direction based on signals from sensors of the motor vehicle that describe all six degrees of freedom in space.
